(19) United States
(12) Patent Application Publication
(10) Pub. No.: US 2005/0035501 A1
(43) Pub. Date: Feb. 17, 2005

(54) Heat-resistant ceramic core with three-dimentional shape and method of manufacturing cast by the same

(75) Inventor: Kazuyoshi Chikugo, Tokyo (JP)

Correspondence Address: GRIFFIN & SZIPL, PC, SUITE PH-1, 2300 NINTH STREET, SOUTH, ARLINGTON, VA, 22204, US

(73) Assignee: Ishikawajima-Harima Heavy Industries Co., Ltd., Tokyo (JP)

(21) Appl. No.: 10/743,379

(22) Filed: Dec. 23, 2003

(30) Foreign Application Priority Data
May 12, 2003 (JP) 132646/2003

(51) Int. Cl. B28B 1/00

(52) U.S. Cl. 264/621; 264/643

(57) ABSTRACT

A method of manufacturing a heat-resistant ceramic core with a three-dimensional shape, which is used to cast a hollow flow passage inside by precision casting. The method includes a powder lamination shaping step for forming ceramic core 2 with a three-dimensional shape from resin-covered ceramic powder 1, an impregnation step for impregnating ceramics reinforcing liquid 3 into the formed ceramic core 2, and a sintering step for sintering the impregnated ceramic core 2 to improve the heat resistance thereof.

### BACKGROUND OF THE INVENTION

1. Field of the Invention

The present invention relates to a heat-resistant ceramic core with a three-dimensional shape and a method of manufacturing a cast by using the core.

2. Description of Related Art

A cast component made of a super-alloy with a complicated inner flow channel to cool the interior thereof is used for a turbine blade or a turbine nozzle for a gas turbine. Conventionally, such a cast component has been manufactured by a precision casting method, and a heat-resistant ceramic core is used to form a hollow flow channel with a three-dimensional shape inside the cast component.

An assembly structure is used as the heat-resistant ceramic core (see Patent Literature 1) to form a complicated hollow flow channel with the three-dimensional shape.

[Patent Literature 1]

Official publication of Japanese Patent No. 502159, 2003

According to Patent Literature 1 “Multi-fragment core assembly for cast blade,” the ceramic core assembly is used to cast a blade made of a super-alloy. As shown in FIG. 1, a plurality of core elements are assembled into a three-dimensional shape.

In the multi-fragment core assembly of Patent Literature 1, a plurality of core elements 51, 52, and 53 are assembled into the three-dimensional shape, so each core element is limited only to a shape with which the element can be individually manufactured. Therefore, if the shape is three-dimensionally complicated, core elements cannot be easily designed and manufactured, and often cannot be applied to the complicated shape.

If a three-dimensionally shaped ceramic body (compact) is manufactured by a powder lamination shaping method, because an organic binder bonds the ceramic powder, the heat resistance thereof becomes poor, and the ceramic body cannot be used as the ceramic core for a heat-resistant alloy cast.

### SUMMARY OF THE INVENTION

The present invention aims to solve the aforementioned problems. That is, an object of the present invention is to provide a heat-resistant ceramic core that can be used as a ceramic core with a complicated three-dimensional shape for application to a heat-resistant alloy, and a method of manufacturing a cast product by using the core.

The present invention provides a method for manufacturing a heat-resistant ceramic core with a three-dimensional shape that is used to cast a hollow flow passage in the interior of the cast product by precision casting. This method comprises a powder lamination shaping step for forming the ceramic core with a three-dimensional shape from ceramic powder covered with a resin, an impregnation step for impregnating the formed ceramic core with ceramics reinforcing liquid, and a sintering step for sintering the ceramic core that is impregnated to strengthen the heat resistance thereof.

According to the above-mentioned method of the present invention, because the ceramic core with a three-dimensional shape is formed by the powder lamination shaping step, even if the shape is complicated, the core can be manufactured easily.

Furthermore, because the formed ceramic core is impregnated with ceramics reinforcing liquid and sintered to strengthen the heat resistance thereof, the ceramic core formed by the powder lamination shaping having poor resistance to heat is made more heat-resistant and can be used as a ceramic core for a heat-resistant alloy.

According to a preferred embodiment of the present invention, the aforementioned ceramics reinforcing liquid is colloidal silica, silica precursor, alumina sol, yttrium oxide sol, niobium oxide sol, or zirconia sol that forms ceramics by sintering.

Using the above-mentioned method, any of these ceramics reinforcing liquids can be easily impregnated into gaps among grains of ceramic powder covered with a resin in the ceramic core formed by the powder lamination shaping. Subsequently, by sintering, the resin cover is thermally decomposed, ceramics are formed at the phase boundary thereof, the shape of the ceramic core can be maintained, and the resistance thereof to heat can be strengthened.

Moreover, in the aforementioned sintering step, it is preferable to put the impregnated ceramic core into a bulk of deformation preventive powder having heat-resistance and heat the ceramic core together with the powder.

Using this method, from the thermal decomposition of the resin covering to the forming of ceramics at the phase boundary, the whole surface of the ceramic core is supported by the heat-resistant powder so that deformation can be prevented.

In addition, using this ceramic core, a cast product with a complicated three-dimensional shape can be manufactured from a super-alloy.

Other objects and advantages of the present invention will become apparent through the following description referring to the attached drawings.

### BRIEF DESCRIPTION OF DRAWINGS

FIG. 1 is a configuration view of a conventional ceramic core assembly.

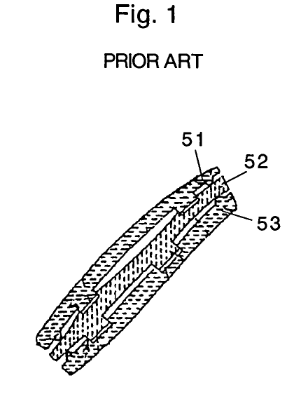

FIG. 2 is a flow chart of the method for manufacturing a heat-resistant ceramic core according to the present invention.

FIG. 3 is a flow chart of a precision casting method using the heat-resistant ceramic core manufactured according to FIG. 2.

### DESCRIPTION OF PREFERRED EMBODIMENTS

Preferred embodiments of the present invention are described below referring to the drawings. In each drawing, common portions are identified with the same reference numbers, and overlapping description is omitted.

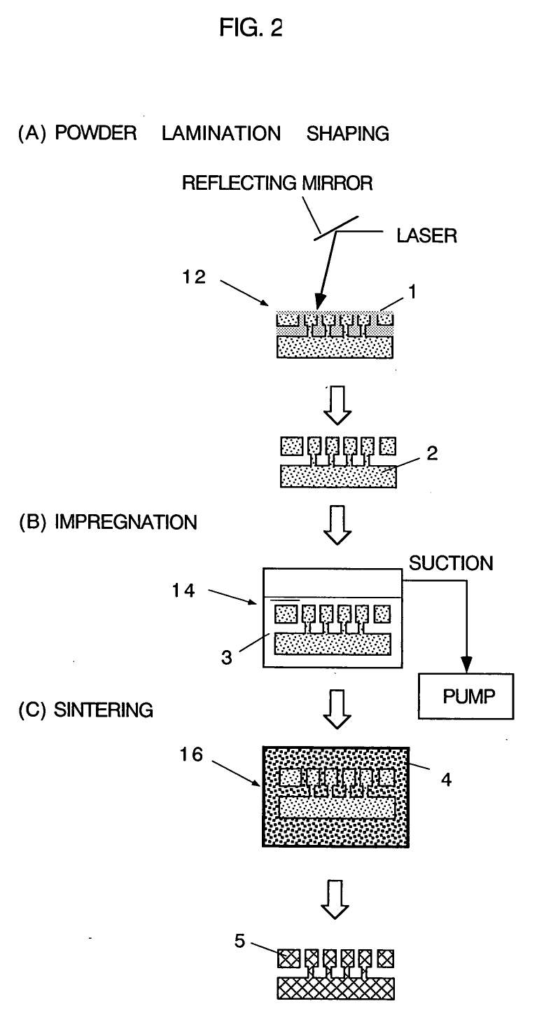

FIG. 2 is a flow chart of the method of manufacturing the heat-resistant ceramic core according to the present invention. According to this method, the heat-resistant ceramic core with a three-dimensional shape, used to cast a hollow flow passage internally by a precision casting method, is manufactured. As shown in FIG. 2, the method of the present invention is composed of a powder lamination shaping step 12, an impregnation step 14, and a sintering step 16.

In the powder lamination shaping step 12, ceramic core 2 with a three-dimensional shape is formed by the powder lamination shaping method from resin-covered ceramic powder 1. An example of the resin-covered ceramic powder 1 that is covered with the resin is zircon powder or silica powder covered with a phenol resin.

An example of the powder lamination shaping method is a widely known laser sintering method whereby ceramic core 2 with the three-dimensional shape can be formed directly from three-dimensional CAD data.

In the ceramic powder 1 that is a material of the ceramic core 2 formed by the powder lamination shaping method, the resin film on the surface of each grain thereof is molten and grains are bonded together. However, the resin film itself is not heat-resistant, and the film is thermally decomposed at a low temperature (200 to 400 degrees centigrade), losing bonding force.

Therefore, in the impregnation step 14 of the present invention, ceramics reinforcing liquid 3 is impregnated into the formed ceramic core 2. This ceramics reinforcing liquid 3 is an inorganic binder. At the impregnation step, it is preferred that the liquid is impregnated in a pressure reduced vessel, so that air contained in the formed body (ceramic core) is replaced smoothly with the inorganic binder. This step should be operated for about 5 to 10 minutes, for instance.

Colloidal silica, silica precursor, alumina sol, yttrium oxide sol, niobium oxide sol, or zirconia sol, which form ceramics when sintered, is used as the ceramics reinforcing liquid 3.

Although one of these ceramics reinforcing liquids is sometimes used alone, some of them can be combined and used, if so required.

The ceramics reinforcing liquid cannot be made satisfactorily heat resistant by impregnation alone. Therefore, in the sintering step 16 of the present invention, the impregnated ceramic core is sintered to enhance the heat resistance thereof. In this step, to remove the resin film by decomposing it thermally, the core is preheated to about 200 to 400 degrees centigrade, and the core is then maintained at a high temperature for several hours according to the characteristics of the ceramics reinforcing liquid.

Colloidal silica is composed of amorphous silica grains with negative charges that are diffused in water in a colloidal state. When such colloidal silica is dried, it turns into a dry gel, that is, a tough dry-gel solid. At about 800 degrees centigrade or more, silica grains are surface-bonded. When this colloidal silica is used, the core should be maintained at, for instance, 1100 to 1400 degrees centigrade for 2 to 3 hours.

The silica precursor reacts water with a catalyst, and eventually becomes silica (SiO₂). Also in the case of the precursor, surface bonding between silica grains occurs by heating in the same way as the colloidal silica.

Alumina sol is liquid with colloidal alumina (Al₂O₃) being diffused therein. If sintered at 800 degrees centigrade or less, the alumina sol becomes amorphous, and if sintered at 1100 degrees centigrade or more, alumina sol changes into α-alumina with a high heat resistance.

Yttrium oxide sol is aqueous solution composed of super-micro-granular yttrium oxide. If dried, the sol becomes amorphous powder, and if sintering the sol at 700 degrees centigrade or more, the sol produces yttrium oxide having a cubic system.

Niobium oxide sol is stabilized aqueous solution containing niobium oxide. When dried, the niobium oxide sol produces an oxide film with a high purity and a uniform composition.

Zirconia sol is solution with diffused colloidal zirconia. By sintering the zirconia sol at a high temperature, the sol exhibits high resistance to heat.

Preferably, in the aforementioned sintering step 16, from the thermal decomposition of the resin cover to the formation of the ceramics at the phase boundary, the entire surface of ceramic core 2 is held by heat-resistant powder 4. In other words, the impregnated ceramic core 2 is put into the heat-resistant powder to prevent the core from being deformed, and the ceramic core is heated together with the heat-resistant powder.

After this sintering step 16, the heat-resistant ceramic core 5 is completed by removing heat-resistant powder 4.

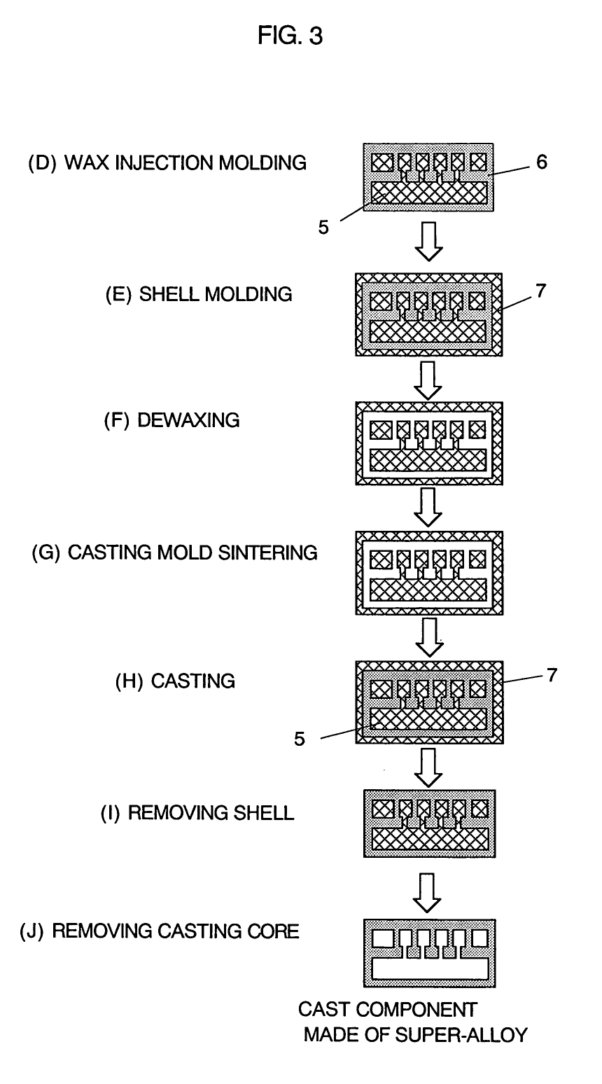

FIG. 3 is a flow chart of the precision casting method that uses the manufactured heat-resistant ceramic core 5 according to the present invention. As shown in FIG. 3, the manufactured heat-resistant ceramic core 5 is confined in wax 6 in a wax injection molding step (D), and a heat-resistant shell 7 is formed therearound in a shell forming step (E). The wax 6 existing between this heat-resistant ceramic core 5 and the shell 7 corresponds to the shape of the cast component to be manufactured using a super-alloy.

The wax 6 is molten and removed in a dewaxing step (F). Subsequently, in a casting mold sintering step (G), the heat-resistant ceramic core 5 and shell 7 are sintered and strengthened, in a casting step (H), the super-alloy is cast between heat-resistant ceramic core 5 and shell 7, in a shell-removing step (I), the shell 7 is removed mechanically, and in a core removing step (J), the heat-resistance ceramic core 5 is solved and removed by alkaline liquid. Thus the cast component made of the super-alloy is completed.

Preferably, the metal of the cast component produced by using the aforementioned ceramic core is a heat-resistant alloy such as Ni group super-alloy and Ti alloy.

As mentioned above, according to the manufacturing method of the present invention, an integrated, three-dimensionally shaped ceramic core for a heat-resistant alloy can be manufactured by specially treating the ceramic body produced by a powder lamination casting method, and the ceramic body can be used as the casting core for the heat-resistant alloy.

In other words, according to the above-mentioned method of the present invention, because the ceramic core with the three-dimensional shape is formed by the powder lamination casting method, the core can be easily manufactured even if the shape is complicated.

In addition, because the ceramics reinforcing liquid is impregnated into the formed ceramic core, and the core is sintered and the heat resistance thereof is bolstered, the ceramic core formed by the heat-vulnerable powder lamination shaping step is made heat-resistant, and can be used as a ceramic core for a heat-resistant alloy.

In summary, the method of the present invention provides the following advantages.

(1) A three-dimensionally shaped ceramic body can be formed integrally.

(2) The ceramic body created by a low heat-resistant lamination shaping method can be used as the casting core of ceramics for a heat-resistant alloy.

(3) The process of the method using a ceramic core in a conventional precision casting method can be used without modifications.

Therefore, the heat-resistant ceramic core and the method of manufacturing a cast product thereof according to the present invention provide various advantages such that a heat-resistant ceramic core with a complicated three-dimensional shape and applicable to the ceramic core for a heat-resistant alloy can be manufactured with excellent resistance to heat.

Of course, the present invention is not limited to the aforementioned embodiments and examples, and can be modified in various ways without departing from the scope of the claims of the present invention.

1. A method of manufacturing a heat-resistant ceramic core with a three-dimensional shape used to cast a hollow flow passage inside by precision casting, comprising:
a powder lamination shaping step for forming a ceramic core with the three-dimensional shape from resin-covered ceramic powder;
an impregnation step for impregnating ceramics reinforcing liquid into the formed ceramic core; and
a sintering step for sintering the impregnated ceramic core to strengthen the heat resistance thereof.

2. The method of manufacturing the heat-resistant ceramic core with a three-dimensional shape specified in claim 1,
wherein the said ceramics reinforcing liquid comprises colloidal silica, silica precursor, alumina sol, yttrium oxide sol, niobium oxide sol, or zirconia sol.

3. The method of manufacturing the heat-resistant ceramic core with a three-dimensional shape specified in claim 1,
wherein the impregnated ceramic core is placed in heat-resistant powder, which prevents the impregnated ceramic core from deforming, and the said core is heated together with the heat-resistant powder.

4. A cast product produced by using the ceramic core based on the method specified in any of claims 1 through 3.
